(19) United States
(12) Patent Application Publication
(10) Pub. No.: US 2005/0142160 A1
(43) Pub. Date: Jun. 30, 2005

(54) ACTIVE ATTRACTANT COMPOSITION FOR INSECTS

(76) Inventor: William C. Hiscox, Spokane, WA (US)

Correspondence Address: GREENBERG & LIEBERMAN, 314 PHILADELPHIA AVE., TAKOMA PARK, MD, 20912, US

(21) Appl. No.: 10/707,672

(22) Filed: Dec. 31, 2003

(51) Int. Cl. A01N 25/08

(52) U.S. Cl. 424/410

(57) ABSTRACT

An attractant for an insect trap functions by creating an attractive smell or other olfactory sensation, or an antennal response which elicits a behavioral response for a flying insect. In the case of the housefly (musca domestica), preferred attractant ingredients are tremethylamine, butyric acid, Z-9-tricosene (muscalure), and egg powder. Highly volatile attractant components are dispensed separately, and all air-borne attractants are mixed and distributed together to enhance the synergistic effects between them. The present invention is the first explicit report of the synergy between chemical attractants (e.g. trimethylamine and butyric acid) and food attractants, such as egg powder. If the attractants of the present invention are packaged in a cartridge, then precise amounts of the discreet chemical attractants can be metered out for optimum attraction of insects. Further, the concentrations of chemical components of the attractant composition comprising the present invention are tightly controlled to avoid objectionable odors, but at the same time, attract flies.

### BACKGROUND OF INVENTION

The present invention is an insect attractant, and more specifically a multi-component attractant based on trimethylamine, butyric acid, Z-9-tricosene, and powdered egg or other dried proteinaceous foodstuff.

There are several types of attractants in use today to direct insects toward a specific location. Chemical insect attractants can be very powerful in luring insects to a particular location, and are widely used in insect traps, poison bait stations, and other killing devices, including electrocution devices. Foodstuffs are sometimes also used as insect attractants. For example, cured ham is used to attract yellowjackets, of the Vespula species, and rotting foodstuffs in water are used to attract flies. In the latter case, the rotting foodstuffs become highly offensive to humans, as well as presenting a biological hazard due to the bacterial soup created in the trap.

The only other major type of attractant for insects is light—especially ultraviolet light—which is a powerful attractant for some insects, but not for all insects. While the patent literature diverse with respect to light-based attraction and trapping devices, none of these are truly effective in real world situations for trapping insects.

Chemical attractants that appeal to a flying insect's olfactory senses can be more effective than visual attractants, and can be used in conjunction with light to increase overall attraction of insects. Pheromones and other chemical communication attractants elicit strong behavioral responses in insects, depending on species.

Several attractant formulations have been disclosed which rely on combinations of attractant chemicals. Mulla, in U.S. Pat. No. 3,996,349, issued on Dec. 7, 1976, first reported a synthetic fly attractant composition, the several ingredients including trimethylamine hydrochloride, ammonium chloride, indole, and linoleic acid, dispersed on fishmeal. Mulla later reported a synergistic effect of trimethylamine hydrochloride and n-butyric acid on anchovy meal.

Warner, in U.S. Pat. No. 5,008,107, issued on Apr. 16, 1991, describes a fly attractant composition which includes trimethylamine hydrochloride, indole or skatole and muscalure (Z-9-tricosene). Yang et al, in U.S. Pat. No. 5,679,363, issued on Oct. 21, 1997, and U.S. Pat. No. 5,399,344, issued on Mar. 21, 1995, disclose a synergistic fly attractant composition of a trialkylamine salt, an alkali salt of a carboxylic acid, and a pheromone in aqueous solution. However, in the crude form in which it was dispensed in all of the above-described baits, the trimethylamine and/or butyric acid is highly offensive to humans, and is difficult to store without emitting a foul odor. The synergy between the chemical components trimethylamine and butyric acid, and foodstuffs was not anticipated in these early patents and has not been previously documented.

Andersen, in U.S. Pat. No. 4,849,216, issued on Jul. 18, 1989, reports the use of poultry liver with a bacterial culture capable of breaking it down, plus a mixture of yeast and sugar, as an attractant for flies in a water-based trap. However, the breakdown products are known to be very repulsive to humans. Harris, in U.S. Pat. No. 3,937,826, issued on Feb. 10, 1976, disclosed the use of two food ingredients together as a fly attractant, one being a granular fish food meat by-product, and the other a yellow sugar-based attractant. All such food-based attractants, when used in drowning traps, pose the same bacteriological breakdown hazard.

The attractants used in water based traps are used in a passive manner, depending on favorable environmental conditions to volatize and distribute attractant into the air above the trap. Passive systems are relatively ineffective, since the attractants are not efficiently distributed in the trap or outside of the trap, where they can be sensed by insects. This is overcome somewhat by the food-based fly attractants, which when decomposing in water, emit a foul odor that is very attractive to flies. This contributes to such attractants becoming unbearably stinky once a number of flies have been caught, due to bacterial breakdown of the carcasses. The traps in which such attractants are based become unhygienic and objectionable to people, and breeding grounds for disease or parasites that any dead insects may have carried during their life cycle. Disposing of insects caught with water-based attractants is another problematic issue, as the resulting bacterial soup of dead insects must be tightly sealed for containment purposes. Objectionable when used outdoors, water-based attractants for flies are definitely not suitable for indoor use for the aforementioned reasons. The same problem is encountered for other drowning traps. Any insect caught in a drowning trap will decompose naturally, creating a biological hazard for the user.

Warner's patent, U.S. Pat. No. 5,008,107, is the first disclosure of a chemical attractant mixture explicitly containing Z-9-tricosene (muscalure, housefly pheromone). Attractants which rely on the aggregation/sex pheromone for the housefly, Z-9-tricosene are known to be ineffective, unless the pheromone can be made volatile enough to be dispersed in the air. Several methods of dispersal have been tried, including resistive heating of the pheromone and agitation with a piezoelectric device. None of these methods results in a truly effective attractant.

Thus, there is no single truly effective means of attracting flies and other flying insects which can be used to properly control flies without causing an offensive odor and/or creating a health hazard due to the accumulation of dead, decaying flies.

Therefore a need has been established for an active attractant to lure flying insects that causes little mess or odor, but is fully effective at luring insects.

### SUMMARY OF INVENTION

The insect attractant functions by creating an attractive smell, antennal response or other olfactory sensation for a flying insect, although not necessarily discernable by a human. In the preferred embodiments of the present invention, the attractants are volatilized and distributed by an active system. Metering of precise amounts of volatile attractants for optimum attraction of insects is desired for optimal function of the trapping or killing device. The attractant is volatized, preferably, through a prearranged chamber or path, such that the insects are lured into the prearranged chamber or path, and the insects are driven to move through the path to gain position closer and closer to the attractant source. The attractant delivered in this manner works in concert with other less volatile attractant ingredients in a synergistic way, since all the attractants are volatized and distributed together. Other secondary attractants may be in powdered form, granular form, or liquid form, and can be placed proximate to the volatile attractant source. Due to the volatility of some of the attractants, they must be dispensed in a tightly controlled manner so that the optimum concentration of volatile attractants is maintained over time, or in other words, so that the desired level of attractant can be maintained in an air/vapor path. Thus, the effectiveness of all attractants used in concert is greatly enhanced in the preferred embodiments of the present invention.

To summarize, the present invention enhances the synergy of volatile insect attractants with low volatility insect attractants by dispensing the volatile components in a tightly controlled manner, while at the same time creating a means of volatizing the relatively non-volatile components. The invention exploits the synergy of chemical insect attractants, such as trimethylamine, with the attractive volatile components of foodstuffs, such as egg powder, using the strategy outlined above. The invention also creates a blend or composition of insect attractants using the above outlined techniques that is highly attractive to insects, but which is not objectionable to humans. Additonally, the invention creates a highly effective insect attractant composition or system which does not decay, and which does not present a bacteriological or health hazard to the user.

### DETAILED DESCRIPTION

The preferred embodiment of the present invention is a combination of trimethylamine, butyric acid, Z-9-tricosene, and egg powder. The chemical components trimethylamine and butyric acid are dispensed in a controlled manner, in order to limit their concentrations to effective levels, those levels remaining under the threshold of human scent detection. The present invention anticipates the use of other alkylamines, ammonia, other carboxylic acids and combinations thereof as insect attractants, and also anticipates the use of other cuticular hydrocarbons related to Z-9-tricosene, some of which are present in houseflies. Other chemical insect attractants, the classes of which are too numerous to mention here, may be incorporated in the present invention, so long as the effective concentrations are maintained as described herein.

Trimethylamine is employed in the present invention because of its superior attractiveness to flies. Trimethylamine is a primary metabolic byproduct of many animals. Other related metabolites include ammonia, methylamine, dimethylamine, and other primary and secondary alkylamines in varying quantities. Trimethylamine is also the primary component of the smell of rotting fish. It is well known that trimethylamine is an attractant for the housefly (mustica domestica), as well as many other species of flies throughout the world. Ammonia is another well-known attractant for flies, and is also present in many species of animals. Ammonia is inferior to trimethylamine as an attractant for flies. However, they may be used in combination.

It is possible to absorb trimethylamine onto clay and other absorbents for use in fly bait formulations. Similar packaging methods have been used by the author of the present invention for use in drowning traps for flies, in which trimethylamine is a principle component. Trimethylamine, absorbed onto a suitable absorbent, can be used in the present invention, although optimum conditions for attractancy within odor threshold limits require more control over the release of the attractant. For example, these absorbents can be used in conjunction with passive release devices, in which the fumes emitted by the absorbent are trapped in a container and allowed to diffuse through an orifice, filter or membrane. In the present invention, control of trimethylamine concentration to levels below the human revulsion threshold makes a trimethylamine-based trap useful indoors, or in spaces where humans will be present. The methods of providing this control include, but are not limited to, diffusion of trimethylamine vapor from the headspace over a solid absorbent; chemically controlled release from an aqueous solution of trimethylamine salts by addition of pH buffers; and mechanical devices capable of metering exact amounts of trimethylamine in aqueous solution or as a gas.

The present invention may incorporate any alkylamine, primary, secondary or tertiary, an aryl amine, or ammonia in place of or in addition to trimethylamine. However, trimethylamine is the preferred amine for fly attraction.

The optimum concentration of trimethylamine is attained by metering a 0.5-5% solution of trimethylamine in water at between 0.1 and 10 microliters per hour using a precision pump or other method. The air concentration of trimethylamine should not be less than 1 ppb (parts per billion, estimated) to be effective, with a maximum concentration of 5 ppm (parts per million, based on experience) before Trimethylamine odor becomes objectionable.

Butyric acid is employed because it is also very attractive to flies. Butyric acid is also a metabolic byproduct of animals and many plants. It exemplifies the effect of air concentration of a fragrance/flavor molecule on odor perception. At very low concentrations, butyric acid smells like pineapple, and is indeed the principal flavor component of pineapple. At slightly higher concentrations it has a butter or rancid butter fragrance, and at still higher concentrations becomes highly objectionable, as in vomit, fecal, or putrid stench odor. Careful control of butyric acid air concentration in combination with trimethylamine, as described above, gives a synergistic effect, while remaining non-objectionable to humans. Butyric acid air concentrations and release rates can be controlled in a similar manner to trimethylamine. However, in aqueous solution, the two can only be used together at a pH of 5-7, where adequate concentrations of both actives are present for fly attraction, but are not at optimum levels. Butyric acid can be dispensed for use in aqueous systems by way of an alkali salt of the carboxylic acid, as well as free butyric acid in water. A water solution of butyric acid at low pH becomes very stinky, as free butyric acid is evolved and volatilized into the air. The opposite is true for trimethylamine, which assumes its “free base” form at higher pH. Butyric acid may also be absorbed directly onto any solid substrate capable of absorbing polar organic liquids or gases, to be released into the airspace in a controlled manner, as described already for trimethylamine. Butyric acid may be substituted for or enhanced by other carboxylic acids, of carbon chain length 1-30, primary or secondary alkyl, branched, unsaturated or aromatic. One example is linoleic acid. Butyric acid has a synergistic effect with trimethylamine as an attractant for houseflies (musca domestica). However, it may be substituted or omitted from attractant formulations without destroying the effectiveness of the remaining attractants in the composition.

The optimum concentration of butyric acid is achieved by metering out a 0.1-5% solution of butyric acid in water at 0.5-10 micro liters per hour. The concentration should not be less than 10 ppb (estimated) to be effective, with a maximum concentration of 20 ppm (estimated) before odors become objectionable. The threshold for objectionable odors from the trimethylamine and butyric acid are not well established. Odor detection, recognition and revulsion thresholds are highly subjective and dependent on age of the subject tester, gender, and other factors. However, relative levels can be established as a decision-making tool when selecting appropriate concentration levels. Muscalure (chemical name Z-9-tricosene or cis-9-tricosene) is the housefly aggregation/sex pheromone, and is found in the cuticular hydrocarbons of flies as one of a series of related waxy hydrocarbons which can be isolated from the cuticle of fly legs and other parts of the fly. Comparison of muscalure against other fly attractants shows it to be a weak fly attractant, and it functions mostly as a local aggregation pheromone. The literature cited above refers to muscalure as a component of several fly attractant compositions. Related compounds that may be used in place of, or in addition to, muscalure include related long-chain Z-alkenes (C10-C30), long chain alkanes (C10-C30), and the oxides of long chain Z-alkenes, referred to as epoxyalkanes, one example of which is cis-epoxytricosane, a minor component of cuticular extracts from flies and a known, but weak, fly attractant. Cis-Epoxytricosane is a solid at room temperature, but has a low volatility and a faint odor.

In practical use, muscalure is a rather ineffective attractant when used either alone or in combination with other attractants, unless it can be made volatile enough to create a vapor phase concentration that can be perceived by flies. Several methods are available for volatizing such large hydrocarbons, such as resistive heating, piezoelectric sonification, and infrared irradiation. Z-9-Tricosene shows a synergistic effect with trimethylamine alone, and in combination with the other attractants comprising the present invention. Inclusion of Z-9-tricosene presents a reinforcing effect on the attractiveness of the overall attractant formula, because it signals to the insect that there are other flies present which are capable of mating. Thus the combination of sex attractant, food source and chemical components becomes irresistible to healthy flies seeking to reproduce.

Without Z-9-tricosene, the present invention would lack an attractant capable of eliciting a sexual behavioral response of the housefly (musca domestica), which is the most common filth fly throughout the world. The optimum concentration of Z-9-tricosene is unknown, and the concentration should not be less than 1 ppm (estimated) to be effective. If too much Z-9-tricosene is volatilized in the trap, trap walls will become greasy with the substance as it re-condenses onto the walls.

Egg powder is a convenient source of protein-based food attractant for flies. Powdered egg may be purchased in either food grade or feed grade, where feed grade egg is not of sufficient quality for human consumption, but is useful as animal feed, and is found in pet food and other staples. The odor of egg powder is due to trace quantities of decomposition products from the egg protein. Some of these compounds, primarily sulfur-containing compounds, are odiferous at very low concentrations. It is widely known, for example, that hydrogen sulfide is a principle component of the odor of rotten eggs. Methyl sulfide, dimethyl sulfide and other alkyl and dialkyl sulfides are also present in the decomposition products of egg proteins. The human recognition threshold for hydrogen sulfide is very low, on the order of fractional parts per billion or less. Likewise, flies are very sensitive to these odors. In comparative testing, egg powder was found to be more attractive to flies than pork liver powder or chicken liver powder. By itself, it is moderately attractive to flies. However, in combination with trimethylamine and butyric acid, a synergistic attractive effect is observed for houseflies.

The synergistic effect between the protein source and the chemical attractants is very important to the success of the attractant system in luring flies into a trap. Without egg powder, for example, the concentrations of butyric acid and trimethylamine used for the indoor traps are barely sufficient to attract the majority of flies. Addition of egg powder to the attractant composition causes a dramatic synergistic effect, allowing the attraction of more flies at lower concentrations of chemical attractant. Alternatively, pork or chicken liver powder, or another animal-derived product, may be substituted for egg and egg and liver may be used together. If egg powder is not used, or egg powder is combined with the aforementioned substitutions, the following are the effects: The synergistic effect of pork or chicken liver powders with the chemical attractants is less than that of egg powder, but is still significant. A slight increase in attractiveness was observed when two or more protein sources were used together.

In the present invention, egg powder is used in quantities between one and five grams, and is used as a dry powder. The presence of egg powder in the trap at these quantities—the powder being distributed over a large surface area exposed to air in the trap—is sufficient to create the synergism. However, circulation of air over the egg powder by a fan or other method of air circulation results in much greater attraction, and allows the use of less attractant per trap to get the same level of egg volatiles attractive to flies.

The present invention anticipates the use of the active chemical components of egg volatiles, or other food source volatiles, in place of egg. However, these are too numerous to list, and the effective concentrations of the individual components can be very low, as noted above. Therefore, egg powder is a very convenient, natural source of these volatiles.

The following interactions can occur between the ingredients of the preferred embodiment of the present invention, and under the following circumstances:Trimethylamine accepts positively charged hydrogen ion to form trimethylammonium ion. Butyric acid easily loses hydrogen ion in aqueous solution to become a negatively charged butyrate ion. The two species may have a weak interaction between them, but probably do not react to form an unproductive or insoluble salt. However, the optimum conditions under which each becomes attractive in water solution is the opposite of one another. A low pH is desirable for evolution of butyric acid from water solutions, whereas high pH is necessary to evolution of trimethylamine from solution. Thus, only rudimentary control of the concentrations of the two chemicals can be achieved when they are both present in solution. In the preferred embodiment of the present invention, the two are dispensed separately in order to maintain optimum air concentrations. There is no known degradation interaction between either trimethylamine or butyric acid and Z-9-tricosene. Furthermore, none of the chemical components are known to react adversely with the food ingredients. Egg powder is stable in the presence of the other attractants, providing that no sugar (or other reducing agent) is present capable of the Malliard reaction, which is known as the chief degradation pathway for proteins in the presence of reducing sugars. This is a known problem in water-based attractants containing both sugar and egg powder, and leads to byproducts which are repellent to flies.

The following variations can occur in amounts of ingredients in alternative embodiments of the present invention, such that the amount of one ingredient can be increased at the expense of the amount of another ingredient being decreased, with the following effects: Substitution of one protein source for another is possible; varying the amounts of either in combination has no deleterious effect. However, egg powder should be used in abundance, if available, since it is the most attractive to flies. The amounts of all other components of the attractant mixture are varied independently, as there is no concentration interdependence as such. One cannot overcome a deficit in trimethylamine by adding more butyric acid, for example.

Control of the concentrations of trimethylamine and butyric acid in the air space of a trap are critical. At higher air concentrations, i.e. greater than 1-5 ppm, trimethylamine and butyric acid can become repellent to both flies and humans. Trimethylamine is toxic to humans at very high concentrations—well above the human revulsion threshold. However, the human olfactory system becomes desensitized to trimethylamine after a brief, chronic exposure (everybody can smell you, but you don't smell anything). Metering out exact amounts of water solutions of trimethylamine and butyric acid is an effective control method to avoid toxicity to humans. In the preferred embodiment, for human health and olfactory concerns, the concentration of trimethylamine should not exceed 5 ppm in air, while the concentration of butyric acid should not exceed 10 ppm. These safety data are based on, but are more conservative than, allowable safe ranges covered on material safety data sheets and other sources. In the preferred embodiment, for so as not to repel flies, the concentration of trimethylamine should not exceed 20 ppm (estimated), while the concentration of butyric acid should not exceed 50 ppm (estimated). These limits are not well established by experiment.

In other embodiments of the present invention, the chemical attractants can be encapsulated or chemically bound as ionic salts, which are then converted to the active forms by chemical reaction in water solution. Control is achieved by carefully measuring the dose of each attractant encapsulated, as well as the chemicals needed to convert to the active forms. The problem with such embodiments is that control is established by equilibrium processes in solution, which are dependent on many factors. However, the most important factor is the pH dependence on concentration of freely available attractants trimethylamine and butyric acid, which have incompatible pH dependencies. Thus, a compromise pH of between 5 and 7 is required if both species are to be present in solution. This can be overcome by using separate solutions in separate containers for each attractant.

Synergy Between Various Attractants In order to test for synergistic effects between attractants, an experimental protocol was set up for comparison of a standard formula against a newly proposed attractant, and a mixture of the new attractant and the standard. The chosen standard attractant composition consisted of separate containers with 1.) trimethylamine solution and 2.) Z-9-tricosene, neat (1.0 g) in a small jar lid. The trimethylamine (TMA) solution was prepared freshly for each experiment by dissolving a known amount of trimethylamine in a solution of sodium bicarbonate in water, to make 6 milliliters total volume. The beaker containing the freshly prepared TMA solution was placed in a large inverted jar lid with another smaller lid containing the Z-9-tricosene, and the large lid was screwed onto the bottom of the trap. Additional attractants were placed in a third jar lid, or otherwise dispersed separately in the lower compartment of the test traps, for comparison against the standard.

A testing room approximately 10 feet by 15 feet was furnished with folding tables on which to place the traps. In such a room was placed a total of six traps, two each of the control, the new attractant, and a combination of control+new attractant. Flies were raised from fly pupae, purchased from Beneficial Insectary, California in a separate room under controlled conditions. For each experiment, after setting up the test traps, around 200 flies were introduced into the room for an 18-24 hour period, and observations were made periodically. At the end of each experiment, flies were counted in each trap, and the remaining flies not trapped were counted in order to account for all flies. In most cases, the remaining flies not caught had expired and were found on the floor of the testing suite. The data are reported for each trap as the percentage of the total flies caught, ignoring the flies not caught. It was observed that a percentage of the initially released flies were always weaker than the main population, and would quickly move toward the floor. Thus, only healthy, active flies were caught, since they were still foraging and seeking mating partners. The experiments were repeated daily, randomly rotating the relative positions of traps in the room with respect to their contents, such that positional effects in the room would be averaged out over many repetitions of the experiment. The results of each experiment, one per day, over one to two weeks, were totaled, and the total catch per attractant type were reported as percentage of catch (% catch).

Results for the testing of egg powder verses the standard were dramatic, and clearly showed a strong synergy between the egg powder and the standard TMA/Z-9. Results are summarized in Table 1.

TABLE 1
Synergy Between Egg Powder & TMA/Z-9

| Attractant | % Catch |
|---|---|
| TMA/Z-9 | 29% |
| Egg Powder | 15% |
| TMA/Z-9 + Egg | 56% |

The combination of TMA/Z-9 and egg powder caught most of the flies, compared to the standard alone or the egg powder alone, in separate daily tests over one week. Other attractants were also screened this way. Once the egg+TMA/Z-9 synergy was established, that combination became the new standard. Results are summarized below in Table 2 for choice experiments with pork and egg powders with and without chemical attractants. A general discussion follows the table.

TABLE 2
Selected Results of Attractant Testing

| Attractant | % Catch |
|---|---|
| TMA/Z-9 | 27% |
| Powdered Pork Liver | 19% |
| Pork Liver/TMA/Z-9 | 54% |
| TMA/Z-9/egg | 33% |
| Pork Liver/TMA/Z-9 | 27% |
| Egg/Pork Liver/TMA/Z-9 | 40% |
| Granulated egg | 30% |
| Powdered egg | 70% |

It can be seen from Table 2 that pork liver also has a synergistic effect with the chemical attractants trimethylamine and Z-9-tricosene. However, compared to egg powder, pork liver is slightly less attractive to houseflies, and the synergy is also slightly weaker. Pork liver was found to be more pungent than egg powder, and was found to have a somewhat objectionable smell. Note that the combination of pork liver and egg was more attractive than egg alone when combined with the two chemical attractants. In later experiments, a new standard was used which consisted of egg powder, Z-9-tricosene and trimethylamine. An alternative source of egg, granulated egg, was less dusty than powdered egg, but was significantly less attractive to flies.

Table 3 summarizes the testing of several other potential attractants against the TMA/Z-9 control. From these experiments it was determined that Z-9-epoxytricosene (heretofore called Z-9-Epoxy, obtained from Aldrich Chemical Company or made by reaction of Z-9-tricosene with 3-chloro-perbenzoic acid) was no more attractive than Z-9-tricosene. Combinations of the two attractants, Z-9 and its epoxide, were not tested, but could potentially have a synergistic effect when used together. Acetic acid was found to be a weak attractant, and had no effect on the attractancy of TMA/Z-9. Ethanol was also found to be a weak attractant, and again had no statistically significant effect on the attractancy of the standard. A commonly used mosquito attractant, 1-octen-3-ol, was non-attractive or repellent to flies, and in combination with the standard, lowered the overall relative catch when compared to the standard alone.

TABLE 3

| Attractant | % Catch |
|---|---|
| TMA/Z-9 | 53% |
| TMA/Z-9-Epoxy | 47% |
| Acetic Acid | 7% |
| TMA/Z-9 | 47% |
| Acetic acid/TMA/Z-9 | 46% |
| Ethanol | 7% |
| TMA/Z-9 | 48% |
| Ethanol/TMA/Z-9 | 46% |
| 1-octen-3-ol | 0% |
| TMA/Z-9 | 67% |
| 1-octen-3-ol/TMA/Z-9 | 33% |

TABLE 4

| Attractant | % Catch |
|---|---|
| TMA/Z-9 | 33% |
| TMA/Z-9/Butyric acid | 67% |
| TMA/Z-9/Egg | 32 |
| TMA/Z-9/Egg/Butyric acid | 68 |

Table 4 shows the results of comparisons of the standard TMA/Z-9 with a combination of butyric acid and the standard TMA/Z-9. It is clear from the results that butyric acid increases the attractiveness of the attractant combination of Z-9 tricosene and trimethylamine with or without egg.

None of the attractants alone is satisfactorily effective, when tested against a room full of flies; therefore, packaging the various attractants is crucial so that storage is possible without decomposition of any one of the ingredients, else the attractant mixture will not be effective. Further, care must be taken to allow the release of the right amount of attractant when the trap is activated.

The packaging of tremethylamine and butyric acid is preferably a cartridge, which meters out precise amounts of attractant for optimum attraction of insects. Whether automatically controlled or via human intervention, the attractants must be metered out so that desired concentrations are maintained.

The liquid attractants, which are trimetylamine in water, butyric acid in water solution, and Z-9-tricosene, and which may include other hydrocarbons, amines, organosulfur compounds, carboxylic acids or alcohols, or other liquids attractive to flies as additional components, can be delivered in the aforementioned manner to work in concert with other attractant ingredients in a synergistic way. The other attractants may be in powdered, granular form, or liquid form. In any event, the attractants must be dispensed in a tightly controlled manner so that the optimum concentration of volatile attractants is maintained over time.

Powdered ingredients consisting of egg powder, granulated dried egg, poultry liver powder, fish meal, and other dried food ingredients, and may include volatile or relatively non-volatile chemical solids like indole, may be either dusted onto the inside surface of an air/vapor reservoir, or alternatively, could be encapsulated in a wet medium. In a preferred embodiment, powdered ingredients, as well as Z-9-tricosene are dispersed in an air filter medium. Z-9-Tricosene, as a liquid, might either be impregnated into the walls of the reservoir, or as an encapsulated solid form, coated onto the surface with the other dry powdered ingredients.

Z-9-tricosene is distinguished from the other liquid attractants in this invention, because of its comparatively high molecular weight, low volatility, and lack of odor under standard conditions. Because it is for all practical purposes non-volatile, it may be used in pure form by simply applying it to a surface within the trap that has a steady air current flowing over it to carry traces of the molecule into the air stream. The more exposed surface area, the better effective volatilization. In any event, without drastic heating, Z-9-tricosene will not lose appreciable mass during the period of use of the trap. Other high molecular weight liquids include many pheromones, which are commercially available for use in traps. The effectiveness of pheromones in attracting specific species of insects may be greatly enhanced by use of a fan or other powered device to increase volatility and distribution of pheromone into the air stream or plume emitting from the trap. Controlled release of pheromone, coupled with an active attractant dispenser, as described, would be many times more effective at attracting specific species of insects to monitoring and control traps, bait stations, and like devices for killing insects. The present invention is not limited to the sole embodiments described above.

1. A compound for attracting insects, comprising:
a metabolite which attracts flies; and
a sex attractant for flies.

2. The compound of claim 1, further comprising a protein compound.

3. The compound of claim 1, wherein said metabolite is an alkylamine, and aryl amine, or an ammonia.

4. The compound of claim 1, wherein said metabolite is a carboxylic acid.

5. The compound of claim 1, wherein said sex attractant for flies is a long-chain Z-alkene (C10-C30), long chain alkane (C10-C30), or an oxide of a long chain Z-alkene.

6. The compound of claim 2, wherein said protein compound is a protein-based food.

7. The compound of claim 1, wherein said metabolite is trimethylamine.

8. The compound of claim 1, wherein said metabolite is butyric acid.

9. The compound of claim 1, wherein said sex attractant is Z-9-tricosene.

10. The compound of claim 2, wherein said protein compound is egg.

11. The compound of claim 2, wherein said protein compound is egg powder.

12. The compound of claim 2, wherein said protein compound is granulated egg.

13. The compound of claim 2, wherein said protein compound is pork.

14. The compound of claim 2, wherein said protein compound is pork liver.

15. The compound of claim 1 wherein further comprising a second metabolite.

16. The compound of claim 15, wherein said first metabolite and said second metabolite are present in a solution having a pH of 5 to 7.

17. A compound for attracting insects, comprising:
an alkylamine, an aryl amine, or an ammonia;
a carboxylic acid;
a long-chain Z-alkene (C10-C30), long chain alkane (C10-C30), or an oxide of a long chain Z-alkene; and
a protein compound.

18. An compound for attracting insects, comprising:
trimethylamine;
butyric acid;
Z-9-tricosene; and
a protein-based food.
